(19) United States
(12) Patent Application Publication
(10) Pub. No.: US 2026/0005719 A1
(43) Pub. Date: Jan. 1, 2026

(54) METHODS, SYSTEMS, AND DEVICES FOR PRIVATE RADIO COMMUNICATION BASED ON POSITION RELATIVE TO A USER

(71) Applicant: Weavix, Inc., Wichita, KS (US)

(72) Inventors: Kevin TURPIN, Wichita, KS (US); Benjamin BURRUS, Wichita, KS (US)

(21) Appl. No.: 18/758,288

(22) Filed: Jun. 28, 2024

(51) Int. Cl. H04B 1/401; G06F 3/16

(52) U.S. Cl. CPC H04B 1/401; G06F 3/16

(57) ABSTRACT

Methods, systems, and devices for private radio communication in frontline work environments are disclosed. In some embodiments, private radio communication is provided by a radio device configured to decrease the audio output volume from the radio device’s speaker when the radio device is positioned near or against the head of a user. The radio device is configured to determine the position of the radio device relative to the user’s head via one or more sensors. In some embodiments the sensors include a photodetector, and the radio device decreases the volume of the audio output based on the incident light detected by the photodetector. In some embodiments, the radio device shifts volumes based further on input from a push-to-talk (PTT) button. In some embodiments the radio device shifts between a PTT mode of operation and a non-PTT mode of operation based on proximity to the user’s head.

### TECHNICAL FIELD

The present disclosure is generally related to wireless communication handsets and systems.

### BACKGROUND

Frontline workers often rely on radios to enable them to communicate with their team members. The nature of frontline work can be highly variable and involve a dynamic range of complex industrial environments. Communication challenges arise because traditional radios may fail to provide adequate functionality in some of these industrial environments. These communication challenges can be compounded by the unsuitability of many conventional communication devices, such as smartphones, tablets, or portable computers, for frontline work. Thus, solutions are needed for communication devices that can accommodate a wide range of operating environments in industrial settings.

### BRIEF DESCRIPTION OF THE DRAWINGS

FIG. 1 is a block diagram illustrating an example architecture for a device for communication and tracking, in accordance with one or more embodiments.

FIG. 2 is a drawing illustrating an example handheld two-way radio transceiver device, in accordance with one or more embodiments.

FIG. 3 is a flowchart illustrating an example method of operating a handheld two-way radio transceiver device, in accordance with one or more embodiments.

FIG. 4 is a flowchart illustrating an example method of operating a handheld two-way radio transceiver device, in accordance with one or more embodiments.

FIG. 5 is a flowchart illustrating an example method of operating a handheld two-way radio transceiver device, in accordance with one or more embodiments.

FIG. 6 is a graphic illustration of parts of the example methods of FIGS. 3–5, in accordance with one or more embodiments.

FIG. 7 is a drawing illustrating an example environment for devices and communication networks for device communication and tracking, in accordance with one or more embodiments.

FIG. 8 illustrates an example of a worksite that includes a plurality of geofenced areas, in accordance with one or more embodiments.

FIG. 9 is a block diagram illustrating an example machine learning (ML) system, in accordance with one or more embodiments.

FIG. 10 is a block diagram illustrating an example computer system, in accordance with one or more embodiments.

### DETAILED DESCRIPTION

Methods, systems and devices for private radio communication in frontline work environments are disclosed. Depending on the situation, radios can be too loud and too difficult to manage for a quick private conversation. For example, users often need to adjust a volume button if they want privacy. The disclosed technology provides for private radio communication simply by holding the radio to the head like a phone. Thus, the user can quickly and efficiently shift from public to private radio communication without manipulating a volume button.

In some embodiments, the radio device is configured to determine the position of the radio device relative to the user’s head via one or more sensors. For example, in some embodiments, the one or more sensors include a photodetector, and the radio device decreases the volume of the audio output based on the incident light or brightness detected by the photodetector. In some embodiments, the one or more sensors include an infrared (IR) detector and the radio device lowers the volume of the audio output based on the IR radiation detected by the IR detector.

In some embodiments, the radio device further includes a push-to-talk (PTT) button configured to enable PTT operations of the radio device when the PTT button is pressed. In some embodiments, operation of the PTT button (e.g., pressing or releasing the PTT button) is used as an input to determine when to decrease the volume of the audio output. This provides the user further control over when to establish a more private operation of the radio device. Additionally, using the PTT button as an input helps avoid inadvertent or accidental shifts in the audio output volume due to a faulty sensor or other undesirable input condition (e.g., accidentally triggering a private mode of operation when the radio device is placed in a pocket or other container, or when the radio device is positioned against or near a body part other than the head).

In some embodiments the radio device is configured to shift between a PTT mode of operation and a non-PTT mode of operation based on proximity to the user’s head. For example, when the radio device is positioned at a relatively high proximity from the user’s head as determined by one or more sensors of the radio device, the radio device is configured to receive audio input when the PTT button is pressed and to cease receiving audio input when the PTT button is released (e.g., a PTT mode of operation). When the one or more sensors of the radio device determine the radio device is a relatively low proximity to the user’s head, the radio device is configured to continuously receive audio input, similar to how a user communicates with a telephone (e.g., a non-PTT mode of operation). In some embodiments, shifting from the PTT mode of operation to the non-PTT mode of operation further includes shifting the communication protocol. For example, when the radio device is positioned away from the head, the PTT mode of operation is enabled and the radio device uses an 802.11 communication protocol. When the radio device is positioned near to the head, the non-PTT mode of operation is enabled and the radio device shifts to using a 5G cellular phone protocol.

In some embodiments, the radio device is configured to shift not only the volume of the audio output, but the source of the audio output. For example, when the radio device determines that the radio device is positioned near or against the user’s head, the source of the audio output shifts from a first speaker to a second speaker. In some embodiments, the second speaker is positioned such that audio output from the second speaker is more proximate to the user’s ear compared to the position of the first speaker, when the radio device is positioned near or against the user’s head in a given manner (e.g., when held against the user’s ear conventionally like a telephone). In some embodiments, the radio device is configured to shift a source of audio input when the radio device is positioned near or against the user’s head. For example, the radio device shifts from a first microphone to a second microphone that is better positioned to detect and receive audio signals from the user when the radio device is positioned near the user’s mouth.

The advantages and benefits of the technology disclosed herein include increasing the capabilities of traditional radio devices to better accommodate a dynamic array of industrial settings, many of which may involve loud, complex machines and unpredictable communication environments. For example, by providing for locally private radio device communication (e.g., private communication between a user and the radio device), radio users can reduce or eliminate distracting radio communications from interfering with workers located near the radio user. This can be particularly valuable in work environments where a number of workers of different teams are required to be proximately close to one another, but where each team needs to be responsive to different communication pathways. This can also be valuable in sensitive work environments where it is critical to reduce or eliminate audio output that could distract workers from performing delicate and/or complicated actions (e.g., manipulating a complicated piece of machinery or handling high-risk substances such as explosives, electrically active elements, or chemically toxic materials). The disclosed technology reduces the likelihood of inadvertently communicating information to individuals who do not need to receive the information and/or situations in which unnecessary distractions are dangerous.

Mobile radio devices (e.g., smart radios) can be used to communicate between various workers. As the responsibilities of these workers adapt with technology, however, the functionality of mobile radio devices must evolve to provide additional functionality. For example, mobile radio devices have been improved to increase connectivity in previously disconnected locations. Moreover, improvements in mobile radio devices enable workers to communicate through additional forms of communication, often without user intervention. Mobile radio devices also provide a mechanism for tracking workers and equipment on a worksite to improve safety and efficiency. Mobile radio devices can further track details about employees during their work shift, and that information can be used to analyze the employees’ strengths and weaknesses. Accordingly, the present disclosure relates to improvements in mobile radio devices. In general, improvements are directed to one of four technical aspects (“pillars”): network connectivity, collaboration, location services, and data, which are explained below.

Network connectivity: Smart radios operate using multiple onboard radios and connect to a set of known networks. This pillar refers to radio selection (e.g., use of multiple onboard radios in various contexts) and network selection (e.g., selecting which network to connect to from available networks in various contexts). These decisions may depend on data obtained from other pillars; however, inventions directed to the connectivity pillar have outputs that relate to improvements to network or radio communications/selections.

Collaboration: This pillar relates to communication between users. A collaboration platform includes chat channel selection, audio transcription and interpretation, sentiment analysis, and workflow improvements. The associated smart radio devices further include interface features that improve ease of communication through reduction in button presses and hands-free information delivery. Inventions in this pillar relate to improvements or gained efficiencies in communicating between users and/or the platform itself.

Location services: This pillar refers to various means of identifying the location of devices and people. There are straightforward or primary means, such as the Global Positioning System (GPS), accelerometer, or cellular triangulation. However, there are also secondary means by which known locations (via primary means) are used to derive the location of other unknown devices. For example, a set of smart radio devices with known locations are used to triangulate other devices or equipment. Further location services inventions relate to identification of the behavior of human users of the devices, e.g., micromotions of the device indicate that it is being worn, whereas lack of motion indicates that the device has been placed on a surface. Inventions in this pillar relate to the identification of the physical location of objects or workers.

Data: This pillar relates to the “Internet of Workers” platform. Each of the other pillars leads to the collection of data. Implementation of that data into models provides valuable insights that illustrate a given worksite to users who are not physically present at that worksite. Such insights include productivity of workers, experience of workers, and accident or hazard mapping. Inventions in the data pillar relate to deriving insight or conclusions from one or more sources of data collected from any available sensor in the worksite.

Embodiments of the present disclosure will now be described with reference to the following figures. Although illustrated and described with respect to specific examples, embodiments of the present disclosure can be embodied in many different forms and should not be construed as limited to the embodiments set forth herein. Accordingly, the examples set forth herein are non-limiting examples referenced to improve the description of the present technology.

### Portable Wireless Devices

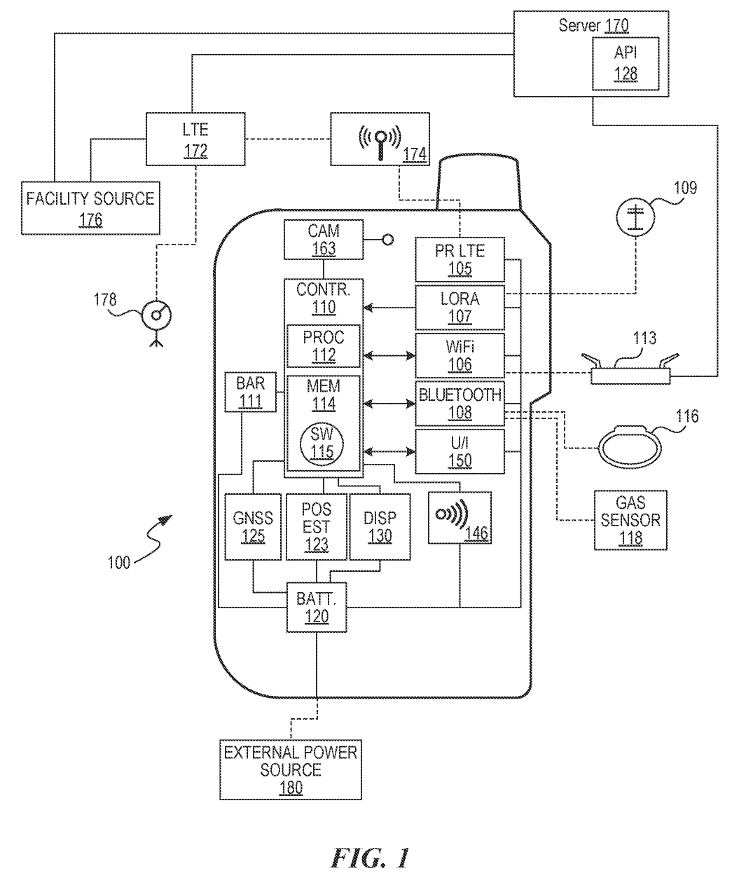

FIG. 1 is a block diagram illustrating an example architecture for a device 100 for device communication and tracking, in accordance with one or more embodiments. The wireless device 100 is implemented using components of the example computer system illustrated and described in more detail with reference to subsequent figures. In embodiments, the device 100 is used to execute the ML system illustrated and described in more detail with reference to subsequent figures. The architecture shown by FIG. 1 is incorporated into a portable wireless device 100, such as a smart radio, a smart camera, a smart watch, a smart headset, or a smart sensor. Although illustrated in a particular configuration, different embodiments of the device 100 include different and/or additional components connected in different ways.

The device 100 includes a controller 110 communicatively coupled either directly or indirectly to a variety of wireless communication arrangements. The device 100 includes a position estimating component 123 (e.g., a dead-reckoning system), which estimates current position using inertia, speed, and intermittent known positions received from a position tracking component 125, which, in embodiments, is a Global Navigation Satellite System (GNSS) component. A battery 120 is electrically coupled with a cellular subsystem 105 (e.g., a private Long-Term Evolution (LTE) wireless communication subsystem), a Wi-Fi subsystem 106, a low-power wide area network (LPWAN) (e.g., LPWAN/long-range (LoRa) network subsystem 107), a Bluetooth subsystem 108, a barometer 111, an audio device 146, a user interface 150, and a built-in camera 163 for providing electrical power.

The battery 120 can be electrically and communicatively coupled with the controller 110 for providing electrical power to the controller 110 and to enable the controller 110 to determine a status of the battery 120 (e.g., a state of charge). In embodiments, the battery 120 is a non-removable rechargeable battery (e.g., using external power source 180). In this way, the battery 120 cannot be removed by a worker to power down the device 100, or subsystems of the device 100 (e.g., the position tracking component 125), thereby ensuring connectivity to the workforce throughout their shift. Moreover, the device 100 cannot be disconnected from the network by removing the battery 120, thereby reducing the likelihood of device theft. In some cases, the device 100 can include an additional, removable battery to enable the device 100 to be used for prolonged periods without requiring additional charging time.

The controller 110 is, for example, a computer having a memory 114, including a non-transitory storage medium for storing software 115, and a processor 112 for executing instructions of the software 115. In some embodiments, the controller 110 is a microcontroller, a microprocessor, an integrated circuit (IC), or a system-on-a-chip (SoC). The controller 110 can include at least one clock capable of providing time stamps or displaying time via display 130. The at least one clock can be updatable (e.g., via the user interface 150, the position tracking component 125, the Wi-Fi subsystem 106, the private cellular network subsystem 107, a server, or a combination thereof).

The wireless communications arrangement can include a cellular subsystem 105, a Wi-Fi subsystem 106, a LPWAN/LoRa network subsystem 107 wirelessly connected to a LPWAN network 109, or a Bluetooth subsystem 108 enabling sending and receiving. Cellular subsystem 105, in embodiments, enables the device 100 to communicate with at least one wireless antenna 174 located at a facility (e.g., a manufacturing facility, a refinery, or a construction site), examples of which may be illustrated in and described with respect to the subsequent figures.

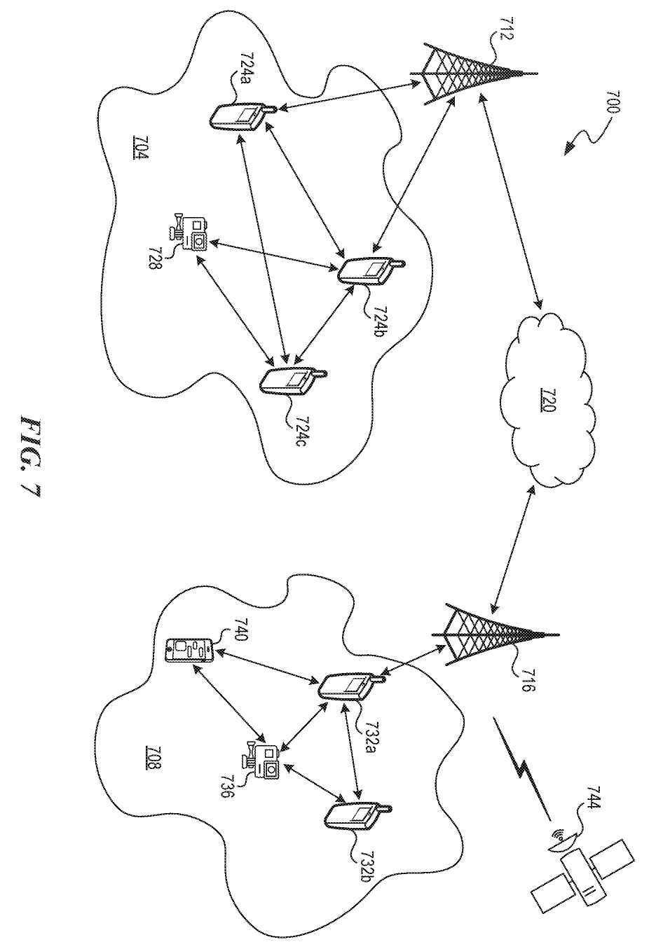

In embodiments, a cellular edge router arrangement 172 is provided for implementing a common wireless source. The cellular edge router arrangement 172 (sometimes referred to as an “edge kit”) can provide a wireless connection to the Internet. In embodiments, the LPWAN network 109, the wireless cellular network, or a local radio network is implemented as a local network for the facility usable by instances of the device 100 (e.g., local network 704 illustrated in FIG. 7). For example, the cellular type can be 2G, 3G, 4G, LTE, 5G, etc. The edge kit 172 is typically located near a facility’s primary Internet source 176 (e.g., a fiber backhaul or other similar device). Alternatively, a local network of the facility is configured to connect to the Internet using signals from a satellite source, transceiver, or router 178, especially in a remotely located facility not having a backhaul source, or where a mobile arrangement not requiring a wired connection is desired. More specifically, the satellite source plus edge kit 172 is, in embodiments, configured into a vehicle, or portable system. In embodiments, the cellular subsystem 105 is incorporated into a local or distributed cellular network operating on any of the existing 88 different Evolved Universal Mobile Telecommunications System Terrestrial Radio Access (EUTRA) operating bands (ranging from 900 MHz up to 2.7 GHz). For example, the device 100 can operate using a duplex mode implemented using time division duplexing (TDD) or frequency division duplexing (FDD).

The Wi-Fi subsystem 106 enables the device 100 to communicate with an access point 113 capable of transmitting and receiving data wirelessly in a relatively high-frequency band. In embodiments, the Wi-Fi subsystem 106 is also used in testing the device 100 prior to deployment. The Bluetooth subsystem 108 enables the device 100 to communicate with a variety of peripheral devices, including a biometric interface device 116 and a gas/chemical detection sensor 118 used to detect noxious gases. In embodiments, numerous other Bluetooth devices are incorporated into the device 100.

As used herein, the wireless subsystems of the device 100 include any wireless technologies used by the device 100 to communicate wirelessly (e.g., via radio waves) with other devices in a facility (e.g., multiple sensors, a remote interface, etc.), and optionally with the Internet (“the cloud”) for accessing websites, databases, etc. For example, the device 100 can be capable of connecting with a conference call or video conference at a remote conferencing server. The device 100 can interface with a conferencing software (e.g., Microsoft Teams^{TM}, Skype^{TM}, Zoom^{TM}, Cisco Webex^{TM}). The wireless subsystems 105, 106, and 108 are each configured to transmit/receive data in an appropriate format, for example, in IEEE 802.11, 802.15, 802.16 Wi-Fi standards, Bluetooth standard, WinnForum Spectrum Access System (SAS) test specification (WINNF-TS-0065), and across a desired range. In embodiments, multiple mobile radio devices are connected to provide data connectivity and data sharing. In embodiments, the shared connectivity is used to establish a mesh network.

The position tracking component 125 and the position estimating component 123 operate in concert. The position tracking component 125 is used to track the location of the device 100. In embodiments, the position tracking component 125 is a GNSS (e.g., GPS, Quasi-Zenith Satellite System (QZSS), BEIDOU, GALILEO, GLONASS) navigational device that receives information from satellites and determines a geographic position based on the received information. The position determined from the GNSS navigation device can be augmented with location estimates based on waves received from proximate devices. For example, the position tracking component 125 can determine a location of the device 100 relative to one or more proximate devices using receives signal strength indicator (RSSI) techniques, time difference of arrival (TDOA) techniques, or any other appropriate techniques. The relative position can then be combined with the position of the proximate devices to determine a location estimate of the device 100, which can be used to augment or replace other location estimates. In embodiments, a geographic position is determined at regular intervals (e.g., every five minutes, every minute, every five seconds), and the position in between readings is estimated using the position estimating component 123.

Position data is stored in memory 114 and uploaded to server at regular intervals (e.g., every five minutes, every minute, every five seconds). In embodiments, the intervals for recording and uploading position data are configurable. For example, if the device 100 is stationary for a predetermined duration, the intervals are ignored or extended, and new location information is not stored or uploaded. If no connectivity exists for wirelessly communicating with server 170, location data can be stored in memory 114 until connectivity is restored, at which time the data is uploaded and then deleted from memory 114. In embodiments, position data is used to determine latitude, longitude, altitude, speed, heading, and Greenwich mean time (GMT), for example, based on instructions of software 115 or based on external software (e.g., in connection with server 170). In embodiments, position information is used to monitor worker efficiency, overtime, compliance, and safety, as well as to verify time records and adherence to company policies.

In some embodiments, a Bluetooth tracking arrangement using beacons is used for position tracking and estimation. For example, the Bluetooth subsystem 108 receives signals from Bluetooth Low Energy (BLE) beacons located about the facility. The controller 110 is programmed to execute relational distancing software using beacon signals (e.g., triangulating between beacon distance information) to determine the position of the device 100. Regardless of the process, the Bluetooth subsystem 108 detects the beacon signals and the controller 110 determines the distances used in estimating the location of the device 100.

In alternative embodiments, the device 100 uses Ultra-Wideband (UWB) technology with spaced-apart beacons for position tracking and estimation. The beacons are small, battery-powered sensors that are spaced apart in the facility and broadcast signals received by a UWB component included in the device 100. A worker’s position is monitored throughout the facility over time when the worker is carrying or wearing the device 100. As described herein, location-sensing GNSS and estimating systems (e.g., the position tracking component 125 and the position estimating component 123) can be used to primarily determine a horizontal location. In embodiments, the barometer 111 is used to determine a height at which the device 100 is located (or operates in concert with the GNSS to determine the height) using known vertical barometric pressures at the facility. With the addition of a sensed height, a full three-dimensional location is determined by the processor 112. Applications of the embodiments include determining if a worker is, for example, on stairs or a ladder, atop or elevated inside a vessel, or in other relevant locations.

In embodiments, the display 130 is a touch screen implemented using a liquid-crystal display (LCD), an e-ink display, an organic light-emitting diode (OLED), or other digital display capable of displaying text and images. In embodiments, the display 130 uses a low-power display technology, such as an e-ink display, for reduced power consumption. Images displayed using the display 130 include, but are not limited to, photographs, video, text, icons, symbols, flowcharts, instructions, cues, and warnings.

The audio device 146 optionally includes at least one microphone (not shown) and a speaker for receiving and transmitting audible sounds, respectively. Although only one audio device 146 is shown in the architecture drawing of FIG. 1, it should be understood that in an actual physical embodiment, multiple speakers or microphones can be utilized to enable the device 100 to adequately receive and transmit audio. In embodiments, the speaker has an output around 105 dB to be loud enough to be heard by a worker in a noisy facility. The microphone of the audio device 146 receives the spoken sounds and transmits signals representative of the sounds to the controller 110 for processing.

The device 100 can be a shared device that is assigned to a particular user temporarily (e.g., for a shift). In embodiments, the device 100 communicates with a worker ID badge using near field communication (NFC) technology. In this way, a worker may log in to a profile (e.g., stored at a remote server) on the device 100 through their worker ID badge. The worker’s profile may store information related to the worker. Examples include name, employee or contractor serial number, login credentials, emergency contact(s), address, shifts, roles (e.g., crane operator), calendars, or any other professional or personal information. Moreover, the user, when logged in, can be associated with the device 100. When another user logs in to the device 100, however, that user can then be associated with the device 100.

### Private Radio Communication Based on Position Relative to a User

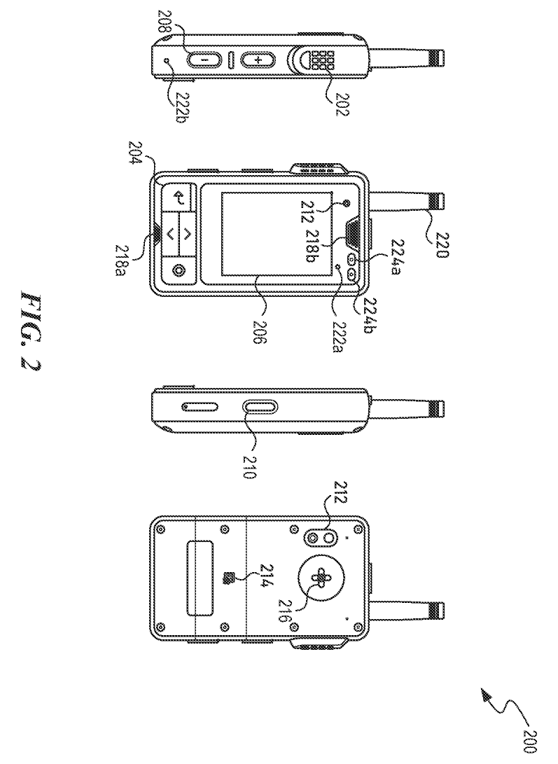

FIG. 2 is a drawing illustrating an example handheld two-way radio transceiver device 200, in accordance with one or more embodiments. In some embodiments, the device 200 includes and/or embodies the architecture of device 100 described in FIG. 1.

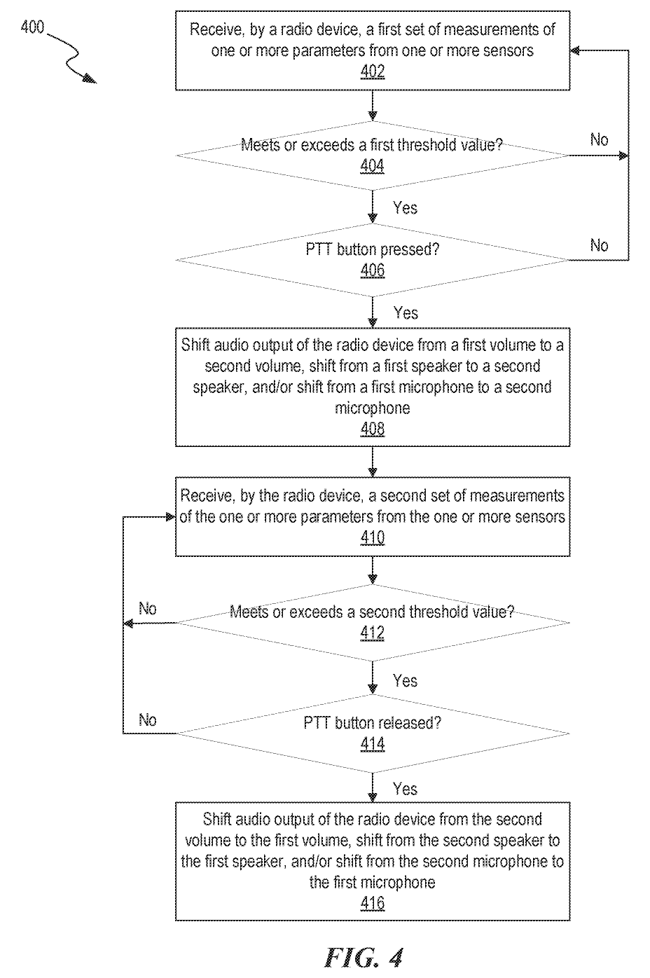

The device 200 includes a user interface that includes a PTT button 202, a 4-button user input system 204, a display 206, an easy to grab volume control 208, and a power button 210. In some embodiments, the PTT button 202 is used to control the transmission of data from or the reception of data by the device 200. For example, the device 200 transmits audio data or other data when the PTT button 202 is pressed and receive audio data or other data when the PTT button 202 is released. In other examples, the PTT button 202 controls the transmission of audio data or other data from the device 200 (e.g., transmit when the PTT button 202 is pressed), though device 200 transmits and receives audio data or other data at the same time (e.g., full duplex communication). As described more in FIGS. 4 and 4, in some embodiments, the PTT button 202 controls the audio output source (e.g., by shifting radio device speakers) and/or where audio input is received by the radio device (e.g., by shifting radio device microphones). In additional embodiments, the PTT button 202 controls the audio output volume of the radio device 200.

The 4-button user input system 204 is used to interact with the device 200. For example, in some embodiments, the 4-button user input system 204 is used as a 4-direction input system (e.g., up-down-left-right), a 2-directional-enter-back (e.g., up-down-enter-back), or any other button configuration. The display 206outputs relevant visual information to the user. In aspects, the display 206 enables touch input by the user to control the device 200. In some embodiments, the volume control 208 controls the loudness of the device 200. The power button 210 turns the device 200 on and off.

The device 200 further includes at least one camera 212, an NFC tag 214, a mount 216, and at least one antenna 220. In some embodiments, the camera 212 is implemented as a front camera capturing the environment in front of the display 206 or a back camera capturing the environment opposite the display 206. The NFC tag 214 is used to connect or register the device 200. For example, the NFC tag 214 registers the device 200 as being docked in a charging station. In yet another example, the NFC tag connects to a worker’s badge to associate the device with the worker. The mount 216 is used to attach the device 200 to the worker (e.g., on a utility belt of the worker). The antenna 220 is used to transmit data from the device 200 or receive data at the device 200. In some cases, transmission or reception by the antenna 220 is controlled by the PTT button 202 or another button of the user interface.

The device 200 further includes a first speaker 218a, a second speaker 218b, a first microphone 222a, and a second microphone 222b. The speakers 218a, 218b output audio received by or presented on the device 200. In some embodiments, the volume of the speakers 218a, 218b is controlled by the volume control 208, input from the PTT button 202, and/or inputs from the first and second sensors 224a, 224b. The first and second microphones 222a, 222b receive audio inputs (e.g., spoken sounds) and transmit signals representative of the sounds to a controller (e.g., the controller 110) for processing. In some embodiments, both of the speakers 218a, 218b and both of the microphones 222a, 222b are configured to operate simultaneously. For example, in some embodiments, both the first and second speakers 218a, 218b provide audio output at the same time. In additional embodiments, only one of each of the first and second speakers 218a, 218b, and one of each of the first and second microphones 222a, 222b is configured to operate at a time. For example, in a first mode of operation the first speaker 218a and first microphone 222a are configured to provide and receive audio signals, respectively. In a second mode of operation, the second speaker 218b and second microphone 222b are configured to provide and receive audio signals, respectively, while the first speaker 218a and first microphone 222a cease providing and receiving audio signals. Further embodiments include any different combination of the first and second speakers 218a, 218b, and first and second microphones 222a, 222b, operating together or individually.

The device 200 further includes a first sensor 224a and a second sensor 224b. In some embodiments, the device 200 includes only one of the first and second sensors 224a, 224b. In additional embodiments, additional sensors (not shown) are included. The first and second sensors 224a, 224b are configured to detect and measure one or more parameters and/or one or more sets of parameters. For example, in some embodiments, the first and second sensors 224a, 224b are photodetectors (e.g., photosensors, light sensors, photodiodes) configured to detect and measure light. In additional embodiments, the first and second sensors 224a, 224b are infrared (IR) sensors (e.g., IR detectors, IR receivers) configured to detect and measure infrared radiation. In some embodiments the first sensor 224a is a different type of sensor than the second sensor 224b. In additional embodiments, both sensors 224a, 224b are the same type of sensor.

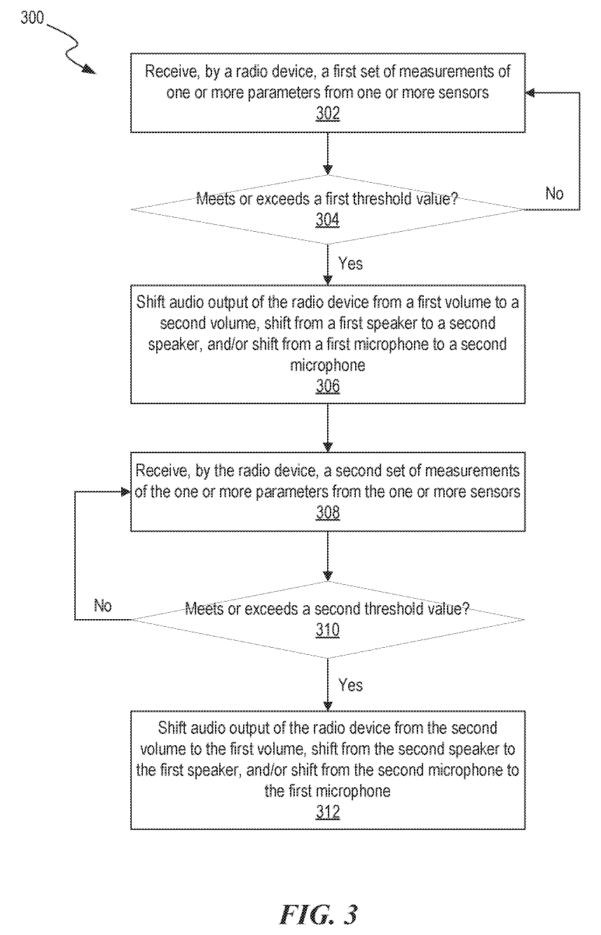

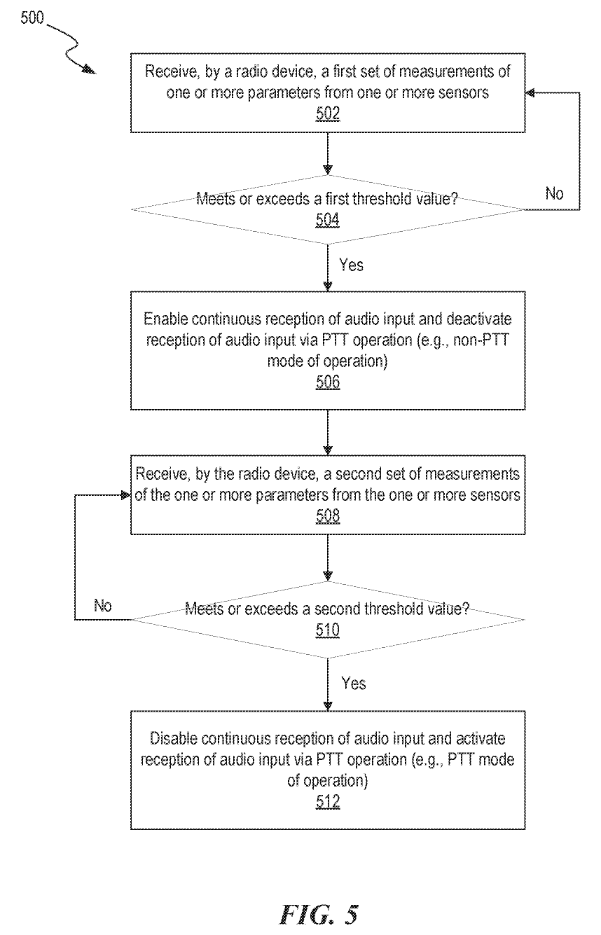

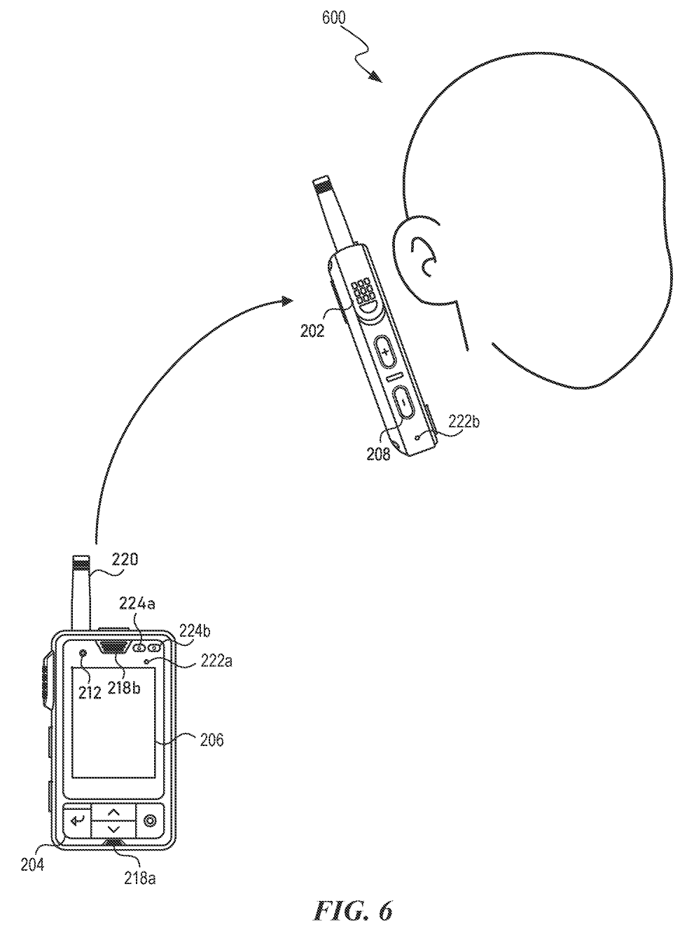

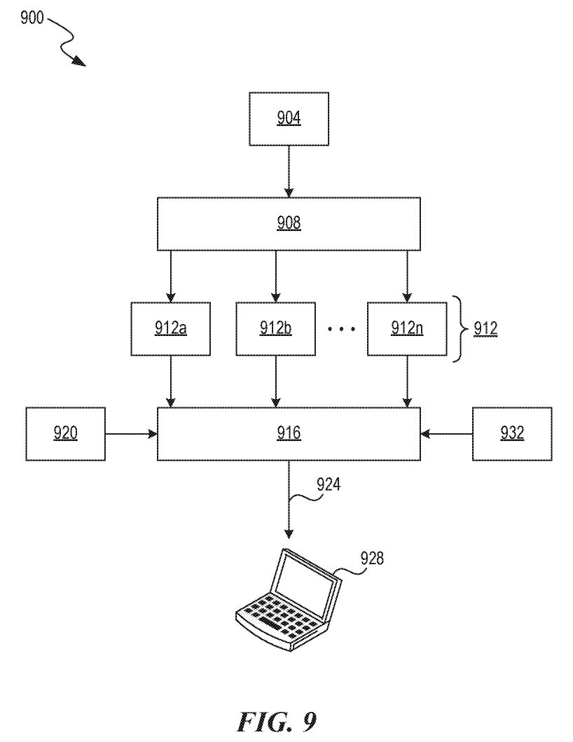

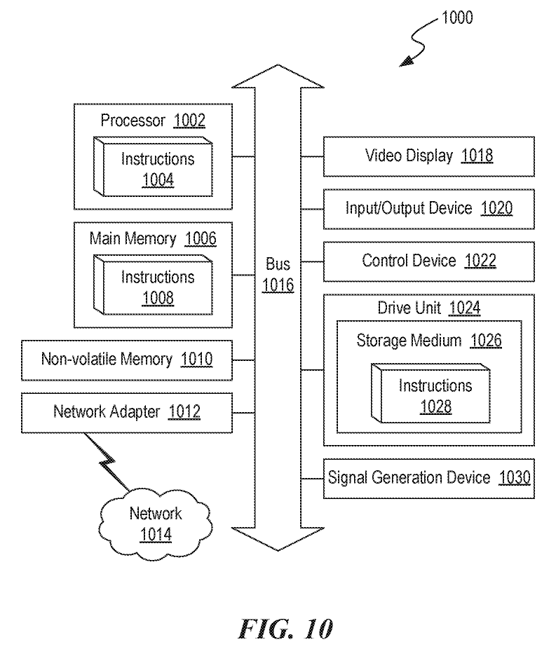

FIGS. 3–5 are flowcharts illustrating various example methods of operating a handheld two-way radio transceiver device, in accordance with one or more embodiments. FIG. 6 is a graphic illustration of parts of the example methods of FIGS. 3–5, in accordance with one or more embodiments. For clarity, FIG. 6 will be discussed together with FIGS. 3–5. The methods 300 of FIG. 3, 400 of FIG. 4, and 500 of FIG. 5 include and/or embody devices such as those of the architecture described in FIG. 1 (e.g., device 100), and/or the device 200 described in FIG. 2. At least some of the blocks of methods 300, 400, and 500 can be performed on systems similar to the machine learning (ML) system described in FIG. 9, and/or the computer system described in FIG. 10.

Turning to method 300 of FIG. 3, at block 302, a handheld two-way radio transceiver device (also referred to as a radio device) (e.g., device 200) receives a first set of measurements of one or more parameters from one or more sensors. Each of the one or more parameters is indicative of a position of the radio device adjacent to a head of a user. In some embodiments, the one or more parameters include light (e.g., brightness) data, and the one or more sensors include a photodetector (e.g., a photodiode or light sensor). In some embodiments, the one or more parameters include infrared (IR) radiation data, and the one or more sensors include an IR sensor. In some embodiments, the one or more sensors are positioned on or integrated with the radio device. In some embodiments the one or more sensors are external to the radio device. In some embodiments, the radio device includes a first sensor configured to detect and measure a first parameter type. In additional embodiments, the radio device includes a second sensor configured to detect and measure a second parameter indicative of the position of the radio device adjacent to the head of a user, where the second parameter type is different from the first parameter type. In yet further embodiments, the first and second sensors detect and measure the same parameter type.

Referring to FIG. 6 as an example, in some embodiments, a first set of measurements of a first parameter of the one or more parameters represents a decrease in incident light received by a first sensor 224a configured to function as a photodetector. In the example, the decrease in incident light corresponds with the device 200 being positioned proximate to a user’s head 600 (e.g., the user’s ear). Furthermore, the device 200 of FIG. 6 includes a second sensor 224b configured to function as an IR sensor. As the device 200 is brought within a certain proximity (e.g., 3 inches, 2 inches, 1 inch) of the user’s head 600, a first set of measurements of a second parameter represent a decrease in the proximity between the device 200 and the user’s head 600 (e.g., via an increase in IR radiation signal received by the IR sensor), corresponding to the device 200 being positioned proximate to the user’s head 600.

At block 304, the first set of measurements of the one or more parameters (e.g., a first set of measurements for a first parameter, and a first set of measurements for a second parameter) is determined to either meet or exceed a threshold value for each of the one or more parameters. In some embodiments, the threshold value is a pre-programmed value stored in non-transitory memory of the radio device. If the threshold value is satisfied (e.g., the value is met or exceeded), then the audio output of the radio device is shifted from a first volume to a second volume, as shown at block 306. In some embodiments, the first volume is greater than the second volume. In some embodiments, if the threshold value criteria are satisfied (e.g., the threshold value is met or exceeded), then the source of the audio output is shifted from being provided or transmitted by a first speaker to being provided or transmitted by a second speaker. In further embodiments, the audio input shifts from being received by a first microphone to being received by a second microphone.

Referring to FIG. 6, the first threshold value for the first parameter (light) and the first threshold value for the second parameter (IR radiation and/or proximity) is met or exceeded when the device 200 is positioned near the user’s head 600 (e.g., when the device 200 is held against the head like a mobile phone). Since the first threshold values for the first and second parameters are satisfied, the audio output of device 200 is shifted from a first volume to a second volume. In the present example, the first volume is greater than the second volume, meaning the audio output volume is decreased. Thus, locally private communication is enabled.

In some embodiments, as shown by blocks 308–312, the initial audio output volume and configuration is restored. At block 308, a second set of measurements of the one or more parameters from the one or more sensors are received by the radio device. If the second set of measurements meets or exceeds a second threshold value for the one or more parameters (as shown in block 310) then audio output of the radio device is shifted back from the second volume to the first volume (as shown in block 312). In some embodiments, the audio output shifts from being provided by the second speaker to being provided by the first speaker. In some embodiments, the audio input shifts from being received by the second microphone to the first microphone.

Turning to method 400 of FIG. 4, in some embodiments, method 400 is similar to method 300 of FIG. 3 with the exception that method 400 includes a push-to-talk (PTT) button as an input for privacy control. At block 402, a handheld two-way radio transceiver device receives a first set of measurements of one or more parameters indicative of a position of the radio device adjacent to a head of a user from one or more sensors. The one or more sensors are positioned on or integrated with the radio device. In some embodiments the one or more sensors are external to the radio device. The one or more parameters include light data, and the one or more sensors include a photodetector. In some embodiments, the one or more parameters include IR radiation data and the one or more sensors include an IR sensor. In some embodiments, the radio device includes first and second sensors configured to detect first and second parameters, each of which is indicative of the position of the radio device adjacent to the head of the user. The first and second parameters are of different types (e.g., the first parameter is light while the second parameter is IR radiation). In some embodiments, the first and second parameters are of the same type (e.g., light).

At block 404, the first set of measurements of the one or more parameters is determined to either meet or exceed a threshold value for each of the one or more parameters. Additionally, a determination is made regarding whether the push-to-talk (PTT) button of the radio device (e.g., PTT button 202 of FIG. 2 and FIG. 6) is pressed, as shown at block 406. If the threshold value is satisfied (e.g., the value is met or exceeded) and the PTT button is pressed, then the audio output of the radio device is shifted from a first volume to a second volume, as shown at block 408. In some embodiments, if the threshold value criteria and PTT button inputs are satisfied (e.g., the threshold value is met or exceeded and the PTT button is pressed), then the source of the audio output is shifted from being provided or transmitted by a first speaker to being provided or transmitted by a second speaker. In further embodiments, the audio input shifts from being received by a first microphone to being received by a second microphone.

Referring to FIG. 6, the device 200 can be configured to include input from the PTT button 202 for privacy control. The first threshold value for the first parameter (light) and the first threshold value for the second parameter (IR radiation and/or proximity) is met or exceeded when the device 200 is positioned near the user’s head 600 (e.g., like a mobile phone). Additionally, the PTT button 202 is pressed. Since the first threshold values for the first and second parameters are satisfied and the PTT button is depressed, the audio output of device 200 is shifted from a first volume to a second volume. In the present example, the first volume is greater than the second volume, meaning the audio output volume is decreased. Thus, private communication is enabled.

In some embodiments, as shown by blocks 410–416, the initial audio output volume and configuration is restored. At block 410, a second set of measurements of the one or more parameters from the one or more sensors are received by the radio device. If the second set of measurements meets or exceeds a second threshold value for the one or more parameters (as shown in block 412), and if the PTT button is released (as shown in block 414), then audio output of the radio device is shifted back from the second volume to the first volume (as shown in block 416). In some embodiments, the audio output shifts from being provided by the second speaker to being provided by the first speaker. In some embodiments, the audio input shifts from being received by the second microphone to the first microphone.

Turning to method 500 of FIG. 5, in some embodiments, method 500 provides for shifting a radio device from a PTT mode of operation to a non-PTT mode of operation based on proximity to a user’s head. A PTT mode of operation refers to a mode of operation in which audio input is capable of being received by the radio device (e.g., via a microphone of the radio device) when a PTT button and/or switch is actuated (e.g., pressed). A non-PTT mode of operation refers to a mode of operation in which audio input is capable of being received by the radio device independent of whether the PTT button is actuated. For example, a non-PTT mode of operation includes when the radio device is enabled to continuously receive audio input (e.g., pressing and/or releasing a PTT button does not affect the radio device’s capability of receiving audio input).

At block 502 the radio device receives a first set of measurements of one or more parameters from one or more sensors, where each of the one or more parameters is indicative of a position of the radio device adjacent to a head of a user. Similar to method 300 and method 400, in some embodiments, the one or more parameters include light data and IR radiation data, and the one or more sensors include a photodetector and/or IR sensor. The one or more sensors are positioned on or integrated with the radio device. In some embodiments the one or more sensors are external to the radio device. In some embodiments, the radio device includes first and second sensors configured to detect first and second parameters, each of which is indicative of the position of the radio device adjacent to the head of the user. The first and second parameters are of different types (e.g., the first parameter is light while the second parameter is IR radiation). In some embodiments, the first and second parameters are of the same type (e.g., light).

At block 504, the first set of measurements of the one or more parameters is determined to either meet or exceed a threshold value for each of the one or more parameters. If the threshold value is satisfied (e.g., the value is met or exceeded), then a non-PTT mode of operation is enabled, as shown at block 506. Specifically, continuous reception of audio input is enabled, and the ability of the radio device to receive audio input based on actuating and/or pressing a PTT button is deactivated. That is, the radio device is configured such that input from the PTT button does not affect the ability of the radio device to receive audio input at an input location (e.g., a microphone). In some embodiments, shifting to the non-PTT mode of operation further includes shifting the communication protocol of the radio device. For example, the radio device can shift from an 802.11 communication protocol to a 5G cellular phone protocol when the first set of measurements of one or more parameters meets or exceeds the first threshold value.

Referring to FIG. 6, the first threshold value for the first parameter (light) and the first threshold value for the second parameter (IR radiation and/or proximity) is met or exceeded when the device 200 is positioned near the user’s head 600 (e.g., when the device 200 is held against the head like a mobile phone). Since the first threshold values for the first and second parameters are satisfied, continuous reception of audio input of device 200 is enabled, and control of the reception of audio input of device 200 via the PTT button 202 is deactivated.

In some embodiments, as shown by blocks 508–512, the PTT mode of operation is restored. At block 508, a second set of measurements of the one or more parameters from the one or more sensors are received by the radio device. If the second set of measurements meets or exceeds a second threshold value for the one or more parameters (as shown in block 510) then control of reception of audio input via pressing/actuating the PTT button (e.g., the PTT mode of operation) is activated, and continuous reception of audio input by the radio device (e.g., the non-PTT mode of operation) is disabled (as shown in block 512). In some embodiments, shifting to the PTT mode of operation further includes shifting the communication protocol of the radio device. For example, the radio device can shift from a 5G cellular phone protocol to an 802.11 communication protocol when the second set of measurements of one or more parameters meets or exceeds the second threshold value.

### Communication Network

FIG. 7 is a drawing illustrating an example environment 700 for devices and communication networks for device communication and tracking, in accordance with one or more embodiments. The environment 700 includes a cloud computing system 720, cellular transmission towers 712, 716, and local networks 704, 708. Components of the environment 700 are implemented using components of the example computer system illustrated and described in more detail with reference to subsequent figures. Likewise, different embodiments of the device 100 include different and/or additional components and are connected in different ways.

Smart radios 724 (e.g., smart radios 724a-724c), smart radios 732 (e.g., smart radios 732a-b) and smart cameras 728, 736 are implemented in accordance with the architecture shown by FIG. 1. In embodiments, smart sensors implemented in accordance with the architecture shown by FIG. 1 are also connected to the local networks 704, 708 and mounted on a surface of a worksite or worn or carried by workers. For example, the local network 704 is located at a first facility and the local network 708 is at a second facility. In embodiments, each smart radio and other smart device has two Subscriber Identity Module (SIM) cards, sometimes referred to as dual SIM. A SIM card is an IC intended to securely store an international mobile subscriber identity (IMSI) number and its related key, which are used to identify and authenticate subscribers on mobile telephony devices.

A first SIM card enables the smart radio 724a to connect to the local (e.g., cellular) network 704 and a second SIM card enables the smart radio 724a to connect to a commercial cellular tower (e.g., cellular transmission tower 712) for access to mobile telephony, the Internet, and the cloud computing system 720 (e.g., to major participating networks such as Verizon™, AT&T™, T-Mobile™, or Sprint™). In such embodiments, the smart radio 724a has two radio transceivers, one for each SIM card. In other embodiments, the smart radio 724a has two active SIM cards, and the SIM cards both use only one radio transceiver. However, the two SIM cards are both active only as long as both are not in simultaneous use. As long as the SIM cards are both in standby mode, a voice call could be initiated on either one. However, once the call begins, the other SIM card becomes inactive until the first SIM card is no longer actively used.

In embodiments, the local network 704 uses a private address space of Internet protocol (IP) addresses. In other embodiments, the local network 704 is a local radio-based network using peer-to-peer (P2P) two-way radio (duplex communication) with extended range based on hops (e.g., from smart radio 724a to smart radio 724b to smart radio 724c). Hence, radio communication is transferred similarly to addressed packet-based data with packet switching by each smart radio or other smart device on the path from source to destination. For example, each smart radio or other smart device operates as a transmitter, receiver, or transceiver for the local network 704 to serve a facility. The smart devices serve as multiple transmit/receive sites interconnected to achieve the range of coverage required by the facility. Further, the signals on the local networks 704, 708 are backhauled to a central switch for communication to the cellular transmission towers 712, 716.

In embodiments (e.g., in more remote locations), the local network 704 is implemented by sending radio signals between multiple smart radios 724. Such embodiments are implemented in less-inhabited locations (e.g., wilderness) where workers are spread out over a larger work area that may be otherwise inaccessible to commercial cellular service. An example is where power company technicians are examining or otherwise working on power lines over larger distances that are often remote. The embodiments are implemented by transmitting radio signals from a smart radio 724a to other smart radios 724b, 724c on one or more frequency channels operating as a two-way radio. The radio messages sent include a header and a payload. Such broadcasting does not require a session or a connection between the devices. Data in the header is used by a receiving smart radio 724b to direct the “packet” to a destination (e.g., smart radio 724c). At the destination, the payload is extracted and played back by the smart radio 724c via the radio’s speaker.

For example, the smart radio 724a broadcasts voice data using radio signals. Any other smart radio 724b within a range limit (e.g., 1 mile, 2 miles, etc.) receives the radio signals. The radio data includes a header having the destination of the message (smart radio 724c). The radio message is decrypted/decoded and played back on only the destination smart radio 724c. If another smart radio 724b that was not the destination radio receives the radio signals, the smart radio 724b rebroadcasts the radio signals rather than decoding and playing them back on a speaker. The smart radios 724 are thus used as signal repeaters. The advantages and benefits of the embodiments disclosed herein include extending the range of two-way radios or smart radios 724 by implementing radio hopping between the radios.

In embodiments, the local network 704 is implemented using Citizens Broadband Radio Service (CBRS). The use of CBRS Band 48 (from 3550 MHz to 3700 MHz), in embodiments, provides numerous advantages. For example, the use of CBRS Band 48 provides longer signal ranges and smoother handovers. The use of CBRS Band 48 supports numerous smart radios 724 and smart cameras 728 at the same time. A smart device is therefore sometimes referred to as a Citizens Broadband Radio Service Device (CBSD).

In alternative embodiments, the Industrial, Scientific, and Medical (ISM) radio bands are used instead of CBRS Band 48. It should be noted that the particular frequency bands used in executing the processes herein could be different, and that the aspects of what is disclosed herein should not be limited to a particular frequency band unless otherwise specified (e.g., 4G-LTE or 5G bands could be used). In embodiments, the local network 704 is a private cellular (e.g., LTE) network operated specifically for the benefit of the facility. Only authorized users of the smart radios 724 have access to the local network 704. For example, the local network 704 uses the 900 MHz spectrum. In another example, the local network 704 uses 900 MHz for voice and narrowband data for Land Mobile Radio (LMR) communications, 900 MHz broadband for critical wide area, long-range data communications, and CBRS for ultra-fast coverage of smaller areas of the facility, such as substations, storage yards, and office spaces.

The smart radios 724 can communicate using other communication technologies, for example, Voice over IP (VoIP), Voice over Wi-Fi (VoWiFi), or Voice over Long-Term Evolution (VoLTE). The smart radios 724 can connect to a communication session (e.g., voice call, video call) for real-time communication with specific devices. The communication sessions can include devices within or outside of the local network 704 (e.g., in the local network 708). The communication sessions can be hosted on a private server (e.g., of the local network 704) or a remote server (e.g., accessible through the cloud computing system 720). In other aspects, the session can be P2P.

The cloud computing system 720 delivers computing services—including servers, storage, databases, networking, software, analytics, and intelligence—over the Internet to offer faster innovation, flexible resources, and economies of scale. FIG. 7 depicts an exemplary high-level, cloud-centered network environment 700 otherwise known as a cloud-based system. Referring to FIG. 7, it can be seen that the environment centers around the cloud computing system 720 and the local networks 704, 708. Through the cloud computing system 720, multiple software systems are made to be accessible by multiple smart radios 724, 732, smart cameras 728, 736, as well as more standard devices (e.g., a smartphone 740 or a tablet) each equipped with local networking and cellular wireless capabilities. Each of the devices 724, 728, 740, although diverse, can embody the architecture of the device 100 shown by FIG. 1, but are distributed to different kinds of users or mounted on surfaces of the facility. For example, the smart radio 724a is worn by employees or independently contracted workers at a facility. The CBRS-equipped smartphone 740 is utilized by an on- or offsite supervisor. The smart camera 728 is utilized by an inspector or another person wanting to have improved display or other options. Regardless, it should be recognized that numerous devices are utilized in combination with an established cellular network (e.g., CBRS Band 48 in embodiments) to provide the ability to access the cloud software applications from the devices (e.g., smart radios 724, 732, smart cameras 728, 736, smartphone 740).

In embodiments, the cloud computing system 720 and local networks 704, 708 are configured to send communications to the smart radios 724, 732 or smart cameras 728, 736 based on analysis conducted by the cloud computing system 720. The communications enable the smart radio 724 or smart camera 728 to receive warnings, etc., generated as a result of analysis conducted. The employee-worn smart radio 724a (and possibly other devices including the architecture of the device 100, such as the smart cameras 728, 736) is used along with the peripherals shown in FIG. 1 to accomplish a variety of objectives. For example, workers, in embodiments, are equipped with a Bluetooth-enabled gas-detection smart sensor. The smart sensor detects the existence of a dangerous gas or gas level. By connecting through the smart radio 724a or directly to the local network 704, the readings from the smart sensor are analyzed by the cloud computing system 720 to implement a course of action due to sensed characteristics of toxicity. The cloud computing system 720 sends out an alert to the smart radio 724 or smart camera 728, and thus a worker, for example, uses a speaker or alternative notification means to alert other workers so that they can avoid danger.

### Position Estimation

The environment 700 can include one or more satellites 744. The smart radios 724 can receive signals from the satellites 744 that are usable to determine position estimates. For example, the smart radios 724 include a positioning system that implements a GNSS or other network triangulation/position system. In some embodiments, the locations of the smart radios 724 are determined from satellites, for example, GPS, QZSS, BEIDOU, GALILEO, and GLONASS. In some cases, the position determined from the primary positioning system does not satisfy a minimum accuracy requirement, the primary position can only be determined at predetermined intervals, or the primary position cannot be determined at all. Accordingly, additional positioning techniques can be used to augment or replace primary positioning. For example, the smart radio 724a can track its position based on broadcast signals received from proximate devices (e.g., using RSSI techniques or TDOA techniques). In some embodiments, the proximate devices include devices that have transmission ranges that encompass the location of the smart radio 724a (e.g., smart radios 724b, 724c). In some embodiments, the smart radios 724 determine or augment a secondary position estimate based on broadcasts received from a cellular communication tower (e.g., cellular transmission tower 712).

RSSI techniques include using the strength signals within a broadcast signal to determine the distance of a receiver from a transmitter. For instance, a receiver is enabled to determine the signal-to-noise ratio (SNR) of a received signal within a broadcast from a transmitter. The SNR of the received signal can be related to the distance between a receiver and a transmitter. Thus, the distance between the receiver and the transmitter can be estimated based on the SNR. By determining a receiver’s distance from multiple transmitters, the receiver’s position can be determined through localization (e.g., triangulation). In some cases, RSSI techniques become less accurate at larger distances. Accordingly, proximate devices may be required to be within a particular distance for RSSI techniques.

TDOA techniques include using the timing at which broadcast signals are received to determine the distance of a receiver from a transmitter. For example, a broadcast signal is sent by a transmitter at a known time (e.g., predetermined intervals). Thus, by determining the time at which the broadcast signal is received (e.g., using a clock), the travel time of the broadcast signal can be determined. The distance of the smart radios 724 from one another can thus be determined based on the wave speed. In some implementations, as broadcast signals are received from the transmitters, the smart radios 724 determine its relative position from each transmitter through localization, resulting in a more accurate global position (e.g., triangulation). Thus, TDOA techniques can be used to determine device location.

In aspects, the broadcast signals transmitted by proximate devices include information related to a position. For example, broadcast signals sent from the smart radios 724 identify their current location. Broadcast signals sent from cellular communication towers or other stationary devices may not need to include a current location, as the location may be known to the receiving device. In other cases, a cellular communication tower or other stationary device sends a broadcast signal that includes information indicative of a current location of the tower or stationary device. Using the current location of the transmitting devices and the location of the smart radios (e.g., smart radios 724b, 724c) relative to the transmitting devices, a global position of the smart radio 724a can be determined.

In some cases, a barometer is used to augment the position determination of the smart radios 724. For example, RSSI, TDOA, and other techniques are used to determine the distance between a transmitter and a receiver. However, these techniques may not provide information related to the displacement between the transmitter and the receiver (e.g., whether the distance is in the x, y, or z plane). In some cases, the barometer is used to provide relative displacement information (e.g., based on atmospheric conditions) of the smart radios 724. In aspects, the broadcast signals received from the proximate devices include information relating to respective elevation estimates (e.g., determined by barometers at the proximate devices) at each of the proximate devices. The elevation estimates from the proximate devices are compared to the elevation estimate of the smart radio 724a to determine the difference in elevation between the smart radio 724a and the proximate devices (e.g., smart radios 724b, 724c).

In some cases, a target device estimates a location based on proximate devices without analyzing broadcast signals. For example, proximate devices share their calculated location data. The target device (e.g., smart radio 724a) receives location data via any communication technology (e.g., Bluetooth or another short-range communication). One device (e.g., smart radio 724b) shares that it is at location A and another device (e.g., smart radio 724c) is at location B. The target device estimates that it’s located somewhere near A and B (e.g., within a communication range of A and B using the respective communication mechanism). In another aspect, the target device receives location data from multiple proximate devices and combines (e.g., averages) the location data to estimate its position. In yet another example, the target device receives location data from proximate devices via a first communication and uses a second communication to determine the location of the target device relative to the proximate devices. In this way, the location data need not be communicated in the same communication used to determine the relative location of the target device.

As an example, the smart radio 724b determines its location based on a primary location estimate that is augmented with a secondary location estimate. For example, the smart radio 724b receives a primary location estimate. In aspects, the primary location estimate is a GNSS location determined from the satellite 744 or a location estimate determined by communications with the cellular communication tower 712 (e.g., using TDOA, RSSI, or other techniques). In some implementations, the primary location estimate has a measurement error less than 1 foot, 2 feet, 5 feet, 10 feet, or the like. The measurement error may increase based on an environment of the smart radio 724b. For example, the measurement error may be higher if the smart radio 724b is within or surrounded by a densely constructed building.

To improve the measurement accuracy, the smart radio 724b can augment its primary location estimate based on a secondary location estimate. In aspects, the secondary location estimate is determined from broadcast signals transmitted by smart radio 724a, smart radio 724c, smart camera 728, cellular communication tower 712, or another communication device or node (e.g., an access point). Positioning techniques (e.g., TDOA, RSSI, location sharing, or other techniques) can be used to determine a relative distance from the transmitting device. For example, smart radio 724a, smart radio 724c, and smart camera 728 transmit broadcast signals that enable the distance of the smart radio 724b to be determined relative to each transmitting device. The transmitting devices can be stationary or moving. Stationary objects typically have strong or high confidence location data (e.g., immobile objects are plotted accurately to maps). The relative location of the smart radio 724b is determined through triangulation based on the distance from each transmitting device. In aspects, the secondary location estimate has a measurement error of less than 1 inch, 2 inches, 6 inches, or 1 foot. In aspects, the secondary location estimate replaces the primary location estimate or is averaged with the primary location estimate to determine an augmented position estimate with reduced error. Accordingly, the measurement error of the location estimate of the smart radio 724b can be improved by augmenting the primary location estimate with the secondary location estimate.

In some implementations, The location of the equipment is similarly monitored. In this context, mobile equipment refers to worksite or facility industrial equipment (e.g., heavy machinery, precision tools, construction vehicles). According to example embodiments, a location of a mobile equipment is continuously monitored based on repeated triangulation from multiple smart radios 724 located near the mobile equipment (e.g., using tags placed on the mobile equipment). Improvements to the operation and usage of the mobile equipment are made based on analyzing the locations of the mobile equipment throughout a facility or worksite. Locations of the mobile equipment are reported to owners of the mobile equipment or entities that own, operate, and/or maintain the mobile equipment. Mobile equipment whose location is tracked includes vehicles, tools used and shared by workers in different facility locations, toolkits and toolboxes, manufactured and/or packaged products, and/or the like. Generally, mobile equipment is movable between different locations within the facility or worksite at different points in time.

Various monitoring operations are performed based on the locations of the mobile equipment that are determined over time. In some embodiments, a usage level for the mobile equipment is automatically classified based on different locations of the mobile equipment over time. For example, a mobile equipment having frequent changes in location within a window of time (e.g., different locations that are at least a threshold distance away from each other) is classified at a high usage level compared to a mobile equipment that remains in approximately the same location for the window of time. In some embodiments, certain mobile equipment classified with high usage levels is indicated and identified to maintenance workers such that usage-related failures or faults can be preemptively identified.

In some embodiments, a resting or storage location for the mobile equipment is determined based on the monitoring of the mobile equipment location. For example, an average spatial location is determined from the locations of the mobile equipment over time. A storage location based on the average spatial location is then indicated in a recommendation provided or displayed to an administrator or other entity that manages the facility or worksite.

In some embodiments, locations of multiple mobile equipment are monitored so that a particular mobile equipment is recommended for use to a worker during certain events or scenarios. As another example, for a worker assigned with a maintenance task at a location within a facility, one or more maintenance toolkits shared among workers and located near the location are recommended to the worker for use.

Accordingly, embodiments described herein provide local detection and monitoring of mobile equipment locations. Facility operation efficiency is improved based on the monitoring of mobile equipment locations and analysis of different mobile equipment locations.

### Machine-Defined Interactions

The cloud computing system 720 uses data received from the smart radios 724, 732 and smart cameras 728, 736 to track and monitor machine-defined activity of workers based on locations worked, times worked, analysis of video received from the smart cameras 728, 736, etc. The activity is measured by the cloud computing system 720 in terms of at least one of a start time, a duration of the activity, an end time, an identity (e.g., serial number, employee number, name, seniority level, etc.) of the worker performing the activity, an identity of the equipment(s) used by the worker, or a location of the activity. For example, a smart radio 724a carried or worn by a worker would track that the position of the smart radio 724a is in proximity to or coincides with a position of the particular machine.

The activity is measured by the cloud computing system 720 in terms of at least the location of the activity and one of a duration of the activity, an identity of the worker performing the activity, or an identity of the equipment(s) used by the worker. In embodiments, the ML system is used to detect and track activity, for example, by extracting features based on equipment types or manufacturing operation types as input data. For example, a smart sensor mounted on an oil rig transmits to and receives signals from a smart radio 724a carried or worn by a worker to log the time the worker spends at a portion of the oil rig.

Worker activity involving multiple workers can similarly be monitored. These activities can be measured by the cloud computing system 720 in terms of at least one of a start time, a duration of the activity, an end time, identities (e.g., serial numbers, employee numbers, names, seniority levels, etc.) of the workers performing the activity, an identity of the equipment(s) used by the workers, or a location of the activity. Group activities are detected and monitored using location tracking of multiple smart devices. For example, the cloud computing system 720 tracks and records a specific group activity based on determining that two or more smart radios 724 were located in proximity to one another within a particular worksite for a predetermined period of time. For example, a smart radio 724a transmits to and receives signals from other smart radios 724b, 724c carried or worn by other workers to log the time the worker spends working together in a team with the other workers.

In embodiments, a smart camera 728 mounted at the worksite captures video of one or more workers working in the facility and performs facial recognition (e.g., using the ML system). The smart camera 728 can identify the equipment used to perform an activity or the tasks that a worker is performing. The smart camera 728 sends the location information to the cloud computing system 720 for generation of activity data. In embodiments, an ML system is used to detect and track activity (e.g., using features based on geographic locations or facility types as input data).

The cloud computing system 720 can determine various metrics for monitored workers based on the activity data. For example, the cloud computing system 720 can determine a response time for a worker. The response time refers to the time difference between receiving a call to report to a given task and the time of arriving at a geofence associated with the task. In aspects, the cloud computing system 720 can determine a repair metric, which measures the effectiveness of repairs by a worker, based on the activity data. For example, the effectiveness of repairs is machine observable based on a length of time a given object remains functional as compared to an expected time of functionality (e.g., a day, a few months, a year, etc.). In yet another aspect, the activity data can be analyzed to determine efficient routes to different areas of a worksite, for example, based on routes traveled by monitored workers. Activity data can be analyzed to determine the risk to which each worker is exposed, for example, based on how much time a worker spends in proximity to hazardous material or performing hazardous tasks. The ML system can analyze the various metrics to monitor workers or reduce risk.

The cloud computing system 720 hosts the software functions to track activities to determine performance metrics and time spent at different tasks and with different equipment and to generate work experience profiles of frontline workers based on interfacing between software suites of the cloud computing system 720 and the smart radios 724, 732, smart cameras 728, 736, smartphone 740. Tracking of activities is implemented in, for example, Scheduling Systems (SS), Field Data Management (FDM) systems, and/or Enterprise Resource Planning (ERP) software systems that are used to track and plan for the use of facility equipment and other resources. Manufacturing Management System (MMS) software is used to manage the production and logistics processes in manufacturing industries (e.g., for the purpose of reducing waste, improving maintenance processes and timing, etc.). Risk-Based Inspection (RBI) software assists the facility using optimized maintenance business processes to examine equipment and/or structures, and track activities prior to and after a breakdown in equipment, detection of manufacturing failures, or detection of operational hazards (e.g., detection of gas leaks in the facility). The amount of time each worker logs at a machine-defined activity with respect to different locations and different types of equipment is collected and used to update an “experience profile” of the worker on the cloud computing system 720 in real time.

### Geofencing

As described herein, smart radios are configured with location estimating capabilities and are used within a facility or worksite for which geofences are defined. A geofence refers to a virtual perimeter for a real-world geographic area, such as a portion of a facility or worksite. A smart radio includes location-aware devices that inform of the location of the smart radio at various times. Embodiments described herein relate to location-based features for smart radios or smart devices. Location-based features described herein use location data for smart radios to provide improved functionality. In some embodiments, a location of a smart radio (e.g., a position estimate) is assumed to be representative of a location of a worker using or associated with the smart radio. As such, embodiments described herein apply location data for smart radios to perform various functions for workers of a facility or worksite.

Some example scenarios that require radio communication between workers are area-specific, or relevant to a given area of a facility. For example, when machines need repair, workers near the machine can be notified and provided instructions to assist in the repair. Alternatively, if a hazard is present at the facility, workers near the hazard can be notified.

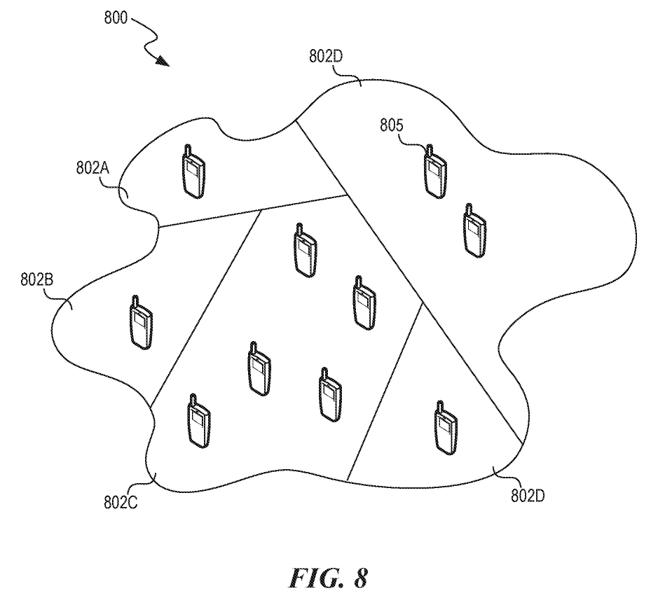

According to some embodiments, locations of smart radios are monitored such that at a point in time, each smart radio located in a specific geofenced area is identified. FIG. 8 illustrates an example of a worksite 800 that includes a plurality of geofenced areas 802, with smart radios 805 being located within the geofenced areas 802.

In some embodiments, an alert, notification, communication, and/or the like is transmitted to each smart radio 805 that is located within a geofenced area 802 (e.g., 802C) responsive to a selection or indication of the geofenced area 802. A smart radio 805, an administrator smart radio (e.g., a smart radio assigned to an administrator), or the cloud computing system is configured to enable user selection of one of the plurality of geofenced areas 802 (e.g., 802C). For example, a map display of the worksite 800 and the plurality of geofenced areas 802 is provided. With the user selection of a geofenced area 802 and a location for each smart radio 805, a set of smart radios 805 located within the geofenced area 802 is identified. An alert, notification, communication, and/or the like is then transmitted to the identified smart radios 805.

### ML System

FIG. 9 is a block diagram illustrating an example ML system 900, in accordance with one or more embodiments. The ML system 900 can implement one or more components of the computer systems and devices discussed herein. Although illustrated in a particular configuration, different embodiments of the ML system 900 include different and/or additional components and are connected in different ways. The ML system 900 is sometimes referred to as an ML module.

The ML system 900 includes a feature extraction module 908 implemented using components of an example computer system, as described herein. In some embodiments, the feature extraction module 908 extracts a feature vector 912 from input data 904. The feature vector 912 includes features 912a, 912b, . . ., 912n. The feature extraction module 908 reduces the redundancy in the input data 904, for example, repetitive data values, to transform the input data 904 into the reduced set of features 912, for example, features 912a, 912b, . . ., 912n. The feature vector 912 contains the relevant information from the input data 904, such that events or data value thresholds of interest are identified by the ML model 916 by using a reduced representation. In some example embodiments, the following dimensionality reduction techniques are used by the feature extraction module 908: independent component analysis, Isomap, principal component analysis (PCA), latent semantic analysis, partial least squares, kernel PCA, multifactor dimensionality reduction, nonlinear dimensionality reduction, multilinear PCA, multilinear subspace learning, semidefinite embedding, autoencoder, and deep feature synthesis.

In alternate embodiments, the ML model 916 performs deep learning (also known as deep structured learning or hierarchical learning) directly on the input data 904 to learn data representations, as opposed to using task-specific algorithms. In deep learning, no explicit feature extraction is performed; the features 912 are implicitly extracted by the ML system 900. For example, the ML model 916 uses a cascade of multiple layers of nonlinear processing units for implicit feature extraction and transformation. Each successive layer uses the output from the previous layer as input. The ML model 916 thus learns in supervised (e.g., classification) and/or unsupervised (e.g., pattern analysis) modes. The ML model 916 learns multiple levels of representations that correspond to different levels of abstraction, wherein the different levels form a hierarchy of concepts. The multiple levels of representation configure the ML model 916 to differentiate features of interest from background features.

In alternative example embodiments, the ML model 916, for example, in the form of a convolutional neural network (CNN), generates the output 924, without the need for feature extraction, directly from the input data 904. The output 924 is provided to the computer device 928. The computer device 928 is a server, computer, tablet, smartphone, smart speaker, etc., implemented using components of an example computer system, as described herein. In some embodiments, the steps performed by the ML system 900 are stored in memory on the computer device 928 for execution. In other embodiments, the output 924 is displayed on a device or electronic displays of a cloud computing system.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 916 is a CNN that includes both convolutional layers and max pooling layers. For example, the architecture of the ML model 916 is “fully convolutional,” which means that variable-sized sensor data vectors are fed into it. For convolutional layers, the ML model 916 specifies a kernel size, a stride of the convolution, and an amount of zero padding applied to the input of that layer. For the pooling layers, the ML model 916 specifies the kernel size and stride of the pooling.

In some embodiments, the ML system 900 trains the ML model 916, based on the training data 920, to correlate the feature vector 912 to expected outputs in the training data 920. As part of the training of the ML model 916, the ML system 900 forms a training set of features and training labels by identifying a positive training set of features that have been determined to have a desired property in question, and, in some embodiments, forms a negative training set of features that lack the property in question.

The ML system 900 applies ML techniques to train the ML model 916, such that when applied to the feature vector 912, it outputs indications of whether the feature vector 912 has an associated desired property or properties, such as a probability that the feature vector 912 has a particular Boolean property, or an estimated value of a scalar property. In embodiments, the ML system 900 further applies dimensionality reduction (e.g., via linear discriminant analysis (LDA), PCA, or the like) to reduce the amount of data in the feature vector 912 to a smaller, more representative set of data.

In embodiments, the ML system 900 uses supervised ML to train the ML model 916, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 932 is formed of additional features, other than those in the training data 920, which have already been determined to have or to lack the property in question. The ML system 900 applies the trained ML model 916 to the features of the validation set 932 to quantify the accuracy of the ML model 916. Common metrics applied in accuracy measurement include Precision and Recall, where Precision refers to a number of results the ML model 916 correctly predicted out of the total it predicted, and Recall is a number of results the ML model 916 correctly predicted out of the total number of features that had the desired property in question. In some embodiments, the ML system 900 iteratively retrains the ML model 916 until the occurrence of a stopping condition, such as the accuracy measurement indication that the ML model 916 is sufficiently accurate, or a number of training rounds having taken place. In embodiments, the validation set 932 includes data corresponding to confirmed locations, dates, times, activities, or combinations thereof. This allows the detected values to be validated using the validation set 932. The validation set 932 is generated based on the analysis to be performed.

### Computing System

FIG. 10 is a block diagram illustrating an example computer system 1000, in accordance with one or more embodiments. At least some operations described herein are implemented on the computer system 1000. The computer system 1000 includes one or more central processing units (“processors”) 1002, main memory 1006, non-volatile memory 1010, network adapters 1012 (e.g., network interface), video displays 1018, input/output devices 1020, control devices 1022 (e.g., keyboard and pointing devices), drive units 1024 including a storage medium 1026, and a signal generation device 1030 that are communicatively connected to a bus 1016. The bus 1016 is illustrated as an abstraction that represents one or more physical buses and/or point-to-point connections that are connected by appropriate bridges, adapters, or controllers. In embodiments, the bus 1016 includes a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an IEEE standard 1394 bus (also referred to as “Firewire”).

In embodiments, the computer system 1000 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1000.

While the main memory 1006, non-volatile memory 1010, and storage medium 1026 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1028. The terms “machine-readable medium” and “storage medium” shall also be taken to include any medium that is capable of storing, encoding, or carrying a set of instructions for execution by the computer system 1000.

In general, the routines executed to implement the embodiments of the disclosure are implemented as part of an operating system or a specific application, component, program, object, module, or sequence of instructions (collectively referred to as “computer programs”). The computer programs typically include one or more instructions (e.g., instructions 1004, 1008, 1028) set at various times in various memory and storage devices in a computer device. When read and executed by the one or more processors 1002, the instruction(s) cause the computer system 1000 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1010, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 1012 enables the computer system 1000 to mediate data in a network 1014 with an entity that is external to the computer system 1000 through any communication protocol supported by the computer system 1000 and the external entity. In embodiments, the network adapter 1012 includes a network adapter card, a wireless network interface card, a router, an access point, a wireless router, a switch, a multilayer switch, a protocol converter, a gateway, a bridge, a bridge router, a hub, a digital media receiver, and/or a repeater.

In embodiments, the network adapter 1012 includes a firewall that governs and/or manages permission to access proxy data in a computer network and tracks varying levels of trust between different machines and/or applications. In embodiments, the firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall additionally manages and/or has access to an access control list that details permissions including the access and operation rights of an object by an individual, a machine, and/or an application, and the circumstances under which the permission rights stand.

In embodiments, the functions performed in the processes and methods are implemented in differing order. Furthermore, the outlined steps and operations are only provided as examples. For example, some of the steps and operations are optional, combined into fewer steps and operations, or expanded into additional steps and operations without detracting from the essence of the disclosed embodiments.

In embodiments, the techniques introduced here are implemented by programmable circuitry (e.g., one or more microprocessors), software and/or firmware, special-purpose hardwired (i.e., non-programmable) circuitry, or a combination of such forms. In embodiments, special-purpose circuitry is in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. It will be appreciated that the same thing can be said in more than one way. One will recognize that “memory” is one form of a “storage” and that the terms are on occasion used interchangeably.

Consequently, alternative language and synonyms are used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

1. A handheld two-way radio transceiver device comprising:
a first sensor configured to detect a first parameter indicative of a position of the handheld two-way radio transceiver device adjacent to a head of a user;
a first speaker configured to provide an audio output;
a processor; and
a memory storing instructions that, when executed by the processor, cause the handheld two-way radio transceiver device to:
receive one or more measurements of the first parameter from the first sensor; and
decrease the audio output from a first volume to a second volume based on the first parameter meeting or exceeding a first threshold value of the first parameter.

2. The device of claim 1, wherein the memory stores instructions that, when executed by the processor, cause the handheld two-way radio transceiver device to:
increase the audio output from the second volume to the first volume based on the first parameter meeting or exceeding a second threshold value of the first parameter.

3. The device of claim 2, further comprising a push-to-talk (PTT) button configured to enable PTT operation of the two-way radio transceiver device via pressing the PTT button, and wherein the memory stores instructions that, when executed by the processor, cause the handheld two-way radio transceiver device to:
enable continuous reception of audio input based on the first parameter meeting or exceeding the first threshold value of the first parameter;
deactivate reception of audio input via pressing the PTT button based on the first parameter meeting or exceeding the first threshold value of the first parameter;
disable continuous reception of audio input based on the first parameter meeting or exceeding the second threshold value of the first parameter; and
activate reception of audio input via pressing the PTT button based on the first parameter meeting or exceeding the second threshold value of the first parameter.

4. The device of claim 2, further comprising a PTT button configured to enable PTT operation of the two-way radio transceiver device via pressing the PTT button, and wherein the memory stores instructions that, when executed by the processor, cause the handheld two-way radio transceiver device to:
decrease the audio output from the first volume to the second volume based further on pressing the PTT button; and
increase the audio output from the second volume to the first volume based further on releasing the PTT button.

5. The device of claim 1, further comprising a second speaker configured to provide the audio output, wherein the memory stores instructions that, when executed by the processor, cause the handheld two-way radio transceiver device to:
shift the audio output from being provided by the first speaker to being provided by the second speaker based on the first parameter meeting or exceeding the first threshold value of the first parameter.

6. The device of claim 1, wherein the first sensor is either a photodetector or an infrared (IR) sensor, and the first parameter is either brightness of light or IR radiation.

7. The device of claim 1, further comprising a second sensor configured to detect a second parameter indicative of the position of the handheld two-way radio transceiver device adjacent to the head of the user, wherein the memory stores instructions that, when executed by the processor, cause the handheld two-way radio transceiver device to:
receive one or more measurements of the second parameter from the second sensor; and
decrease the audio output from the first volume to the second volume based further on the second parameter meeting or exceeding a first threshold value of the second parameter.

8. A radio device comprising:
a first sensor configured to detect a first parameter indicative of a position of the radio device adjacent to a head of a user;
a first speaker configured to provide an audio output;
a processor; and
a memory storing instructions that, when executed by the processor, cause the radio device to:
receive the first parameter from the first sensor; and
shift the audio output from a first volume to a second volume based on the first parameter meeting or exceeding a threshold value of the first parameter.

9. The device of claim 8, wherein the memory stores instructions that, when executed by the processor, cause the radio device to:
shift the audio output from the second volume to the first volume based on the first parameter meeting or exceeding a second threshold value of the first parameter.

10. The device of claim 9, further comprising a push-to-talk (PTT) button configured to enable PTT operation of the radio device via pressing the PTT button, and wherein the memory stores instructions that, when executed by the processor, cause radio device to:
enable continuous reception of audio input based on the first parameter meeting or exceeding the first threshold value of the first parameter;
deactivate reception of audio input via pressing the PTT button based on the first parameter meeting or exceeding the first threshold value of the first parameter;
disable continuous reception of audio input based on the first parameter meeting or exceeding the second threshold value of the first parameter; and
activate reception of audio input via pressing the PTT button based on the first parameter meeting or exceeding the second threshold value of the first parameter.

11. The device of claim 9, further comprising a push-to-talk (PTT) button configured to enable PTT operation of the radio device via pressing the PTT button, and wherein the memory stores instructions that, when executed by the processor, cause the radio device to:
shift the audio output from the first volume to the second volume based further on pressing the PTT button; and
shift the audio output from the second volume to the first volume based on releasing the PTT button.

12. The device of claim 8, further comprising a second speaker configured to provide the audio output, wherein the memory stores instructions that, when executed by the processor, cause the radio device to:
shift the audio output from being provided by one of the first or second speaker to being provided by the other of the first or second speaker based on the first parameter meeting or exceeding the threshold value of the first parameter.

13. The device of claim 8, wherein the first sensor is either a photodetector or an infrared (IR) sensor, and the first parameter is either brightness of light or IR radiation.

14. The device of claim 8, further comprising a second sensor configured to detect a second parameter indicative of the position of the radio device adjacent to the head of the user, wherein the memory stores instructions that, when executed by the processor, cause the radio device to:
receive the second parameter from the second sensor; and
shift the audio output from the first volume to the second volume based further on the second parameter meeting or exceeding a threshold value of the second parameter.

15. A method of enabling locally private communication using a handheld two-way radio transceiver device, the method comprising:
receiving, by the radio transceiver device, a first set of one or more measurements of a first parameter from a first sensor, the first parameter being indicative of a position of the handheld two-way radio transceiver device adjacent to a head of a user;
determining whether the first set of one or more measurements of the first parameter meets or exceeds a first threshold value; and
decreasing an audio output of the radio transceiver device from a first volume to a second volume based on the first threshold value determination of the first parameter.

16. The method of claim 15, further comprising:
receiving, by the radio transceiver device, a second set of one or more measurements of the first parameter from the first sensor;
determining whether the second set of one or more measurements of the first parameter meets or exceeds a second threshold value of the first parameter; and
increasing the audio output of the radio transceiver device from the second volume to the first volume based on the second threshold value determination.

17. The method of claim 16, further comprising:
enabling continuous reception of audio input by the radio transceiver device, based on the first parameter meeting or exceeding the first threshold value of the first parameter;
deactivating reception of audio input by the radio transceiver device via pressing a PTT button of the radio transceiver device, based on the first parameter meeting or exceeding the first threshold value of the first parameter;
activating reception of audio input by the radio transceiver device via pressing the PTT button, based on the first parameter meeting or exceeding the second threshold value of the first parameter; and
disabling continuous reception of audio input by the radio transceiver device, based on the first parameter meeting or exceeding the second threshold value of the first parameter.

18. The method of claim 16, further comprising:
pressing a PTT button of the radio transceiver device;
decreasing the audio output from the first volume to the second volume based further on pressing the PTT button;
releasing the PTT button; and
increasing the audio output from the second volume to the first volume based further on releasing the PTT button.

19. The method of claim 15, further comprising:
providing the audio output of the radio transceiver device via a first speaker of the radio transceiver device; and
shifting the audio output from being provided via the first speaker to being provided via a second speaker of the radio transceiver device based on the first parameter meeting or exceeding the first threshold value of the first parameter.

20. The method of claim 15, further comprising:
receiving, by the radio transceiver device, a first set of one or more measurements of a second parameter from a second sensor, the second parameter being indicative of the position of the handheld two-way radio transceiver device adjacent to the head of the user;
determining whether the first set of one or more measurements of the second parameter meets or exceeds a first threshold value; and
decreasing the audio output of the radio transceiver device from the first volume to the second volume based further on the first threshold value determination of the second parameter.
